(19) United States
(12) Patent Application Publication
(10) Pub. No.: US 2006/0259795 A1
(43) Pub. Date: Nov. 16, 2006

(54) Portable computer and data backup method thereof

(76) Inventors: Hsin-Feng Tsai, Pao Chiao City (TW); Chun-Ching Chen, Tao Yuan City (TW)

Correspondence Address: RABIN & Berdo, PC, 1101 14TH STREET, NW, SUITE 500, WASHINGTON, DC, 20005, US

(21) Appl. No.: 11/289,357

(22) Filed: Nov. 30, 2005

(30) Foreign Application Priority Data
May 10, 2005 (TW) 94115137

(51) Int. Cl. G06F 1/00

(52) U.S. Cl. 713/300

(57) ABSTRACT

A portable computer and data backup method thereof is disclosed. The portable computer includes a hard disk drive (HDD), a data storage device and a control unit. The HDD is for storing data, while the data storage device is for making a backup of the HDD data. The control device is coupled to the HDD and the data storage device. The data backup method includes setting the data storage device in a power off mode or power-saving mode and using the HDD to store data in order to perform a normal-mode operation; and waking up the data storage device to make a backup of the HDD data to perform a backup-mode operation.

This application claims the benefit of Taiwan application Serial No. 94115137, filed May 10, 2005, the subject matter of which is incorporated herein by reference.

### BACKGROUND OF THE INVENTION

1. Field of the Invention

The invention relates in general to a portable computer and a data backup method thereof, and more particularly to a portable computer, which uses a backup hard disk drive (HDD) or a flash disk to backup a main hard disk drive of the portable computer while the portable computer is idle, and data backup method thereof.

2. Description of the Related Art

A portable computer, such as a notebook computer or a tablet personal computer, has characters of small volume, light weight and portability, which are very helpful in an office meeting or a business trip. Owing that the portable computer needs to be moved usually, the portable computer gets damaged easily under inevitable shaking or vibration, thereby influencing the normal operation of the inner hard disk drive of the portable computer.

A current hard disk drive includes a pick-up head and a magnetic surface. Generally speaking, the pick-up head is very close to the magnetic surface in the hard disk drive, so that the signal having enough intensity on the magnetic surface can be read by the pick-up head. However, once the hard disk drive is collided as in operation, the pick-up head will damage the magnetic surface very easily and cause the data on it to get lost. The above-mentioned frequent shaking of the portable computer may not influence the hard disk drive immediately and obviously. Therefore, the issue is very often neglected by the user. However, the hard disk drive of the portable computer will be easily damaged as used for a long period of time.

In order to avoid that the important data in the hard disk drive get damaged, performing a data backup process is the best way to protect the data. A common data backup method used in a server is a redundant array of independent disk (RAID) technique. Or a large-scale industry stores data at two different places for data backup. However, these methods are not applicable to the portable computer. Besides, the common-used data backup methods, such as backup by using a CD-R/DVD-R or an external hard disk drive, should be implemented by a manual process, thereby increasing the complexity of the data backup process. In addition, if the user needs to carry a lot of devices for the data backup use while on a business trip or traveling, that will disobey the portability spirit in design of the portable computer.

### SUMMARY OF THE INVENTION

It is an aspect of the present invention to provide a portable computer and data backup method thereof. A backup hard disk drive (HDD) or a flash disk is disposed in the portable computer. The backup hard disk drive is set in a power-off mode or power-saving mode as a main hard disk drive is in a normal operation. The backup hard disk drive is awakened to perform a data backup operation while the portable computer is not used. Therefore, the purpose of data protection can be achieved without increasing additional steps.

According to the aforementioned aspect of the present invention, a portable computer is provided. The portable computer comprises a hard disk drive, a control unit and a data storage device. The hard disk drive is for storing data. The control unit is coupled to the hard disk drive for outputting a backup command. The data storage device is coupled to the control unit for receiving the backup command and storing the data of the hard disk drive. When the portable computer is set in a normal mode, the hard disk drive is in a power-on state, and the data storage device is in a power-unused mode. When the portable computer is set in a backup mode, the control unit outputs the backup command for waking up the data storage device to save the data of the hard disk drive.

According to the aforementioned aspect of the present invention, a data backup method applied in a portable computer is provided. The portable computer includes a hard disk drive and a data storage device. The data backup method comprises the steps of setting the data storage device in a power-unused mode; using the hard disk drive to store data in order to perform a normal-mode operation; and waking up the data storage device to backup the data of the hard disk drive in order to perform a backup-mode operation.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A depicts a block diagram showing a portable computer in accordance with the preferred embodiment of the invention;

FIG. 1B depicts a block diagram showing a portable computer in the normal operation mode in accordance with the preferred embodiment of the invention;

FIG. 1C depicts a block diagram showing a portable computer in a backup mode in accordance with the preferred embodiment of the invention; and

FIG. 2 depicts a flow chart showing a data backup method in accordance with the preferred embodiment of the invention.

### DETAILED DESCRIPTION OF THE INVENTION

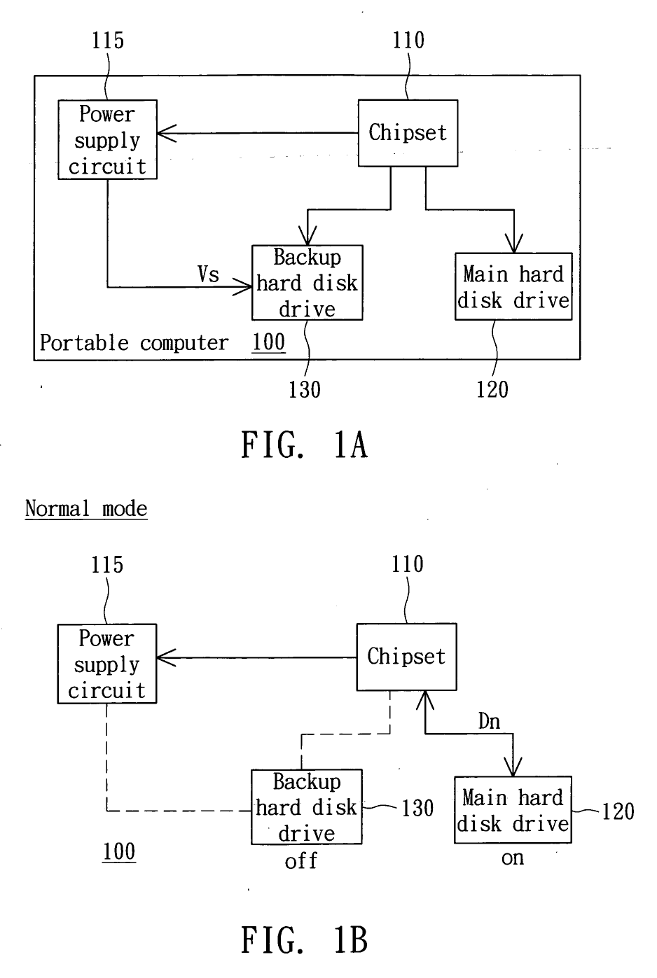

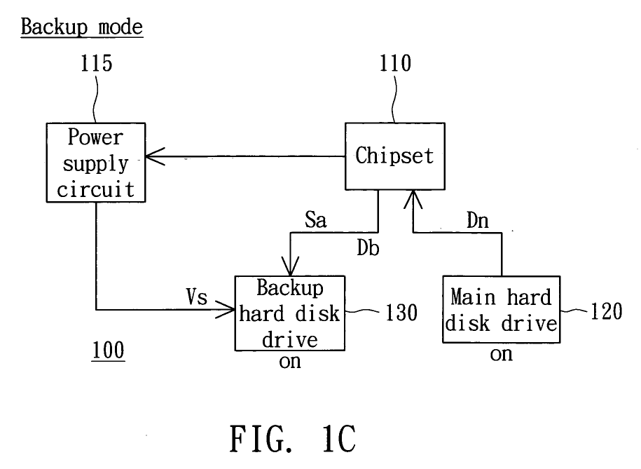

Referring to FIG. 1A, a block diagram of a portable computer according to a preferred embodiment of the present invention is shown. A portable computer 100, such as a notebook computer or a tablet personal computer, includes a chipset 110, a power supply circuit 115, a main hard disk drive 120 and a backup hard disk drive 130. The chipset 110, such as a south bridge chipset, is coupled with both the main hard disk drive 120 and the backup hard disk drive 130. The chipset 110 is used for transferring signals and commands, and reading/writing data. The main hard disk drive 120 is a major hard disk drive used for storing data while the portable computer 100 is operated in a normal mode. The backup hard disk drive 130 is a data storage device used for making a backup of the data in the main hard disk drive 120 while the portable computer 100 is operated in a backup mode. The power supply circuit 115, controlled by the chipset 110 supplies a power Vs to the backup hard disk drive 130 as receiving a notification signal from the power supply circuit 115.

Referring to FIG. 1B, a block diagram of a portable computer operated in a normal mode according to the preferred embodiment of the present invention is shown. When the portable computer 100 is used in a normal condition, that is, set in a normal mode, such as in office hours at the day time, the main hard disk drive 120 is set in a power-on state. The portable computer 100 reads or writes data Dn on the main hard disk drive 120 by using the chipset 110. At the same time, the chipset 110 controls the power supply circuit 115 not to provide the power Vs to the backup hard disk drive 130, and the backup hard disk drive 130 is in a power-off state. Meanwhile, a pick-up head of the backup hard disk drive 130 (not shown) is located at a detent position. Therefore, the above-mention risk that the magnetic surface is bruised and thus the backup hard disk drive 130 is damaged by the pick-up head can be reduced.

Furthermore, referring to FIG. 1C, a block diagram of a portable computer operated in a backup mode according to the preferred embodiment of the present invention is shown. When the portable computer 100 is powered on and set in a backup mode, such as the portable computer 100 is not used after work, at late night or in the early morning, the main hard disk drive 120 is still set in a power-on state. At the same time, the chipset 110 notifies (or controls) the power supply circuit 115 to output the power Vs to the backup hard disk drive 130, and outputs a backup command Sa to wake up the backup hard disk drive 130. Meanwhile, the data Dn of the main hard disk drive 120 are copied as backup data Db, and then saved into the backup hard disk drive 130.

In order to decrease the potential risk of the data damage in a frequent shaking, the backup hard disk drive 130 is configured in the portable computer 100 in the embodiment, and set to perform the backup operation only in a specific duration of a day (Always Off). For example, the backup hard disk drive 130 is set to perform the backup operation automatically or set by the user to backup data stored in office hours only after work, at late night or in the early morning. As a result, owing that the backup hard disk drive 130 almost works within a completely static system, the probability of data loss due to the frequent shaking can be greatly reduced. Therefore, even if the main hard disk drive 120 gets damaged, the data can be retrieved from the backup hard disk drive 130.

As described above, every hard disk drive has its safe collision range. Once the colliding force is large beyond the safe shaking range of the hard disk drive, the data on the hard disk drive can be damaged. Even though the pick-up head of the backup hard disk drive 130 is located at the detent position, it is possible that the hard disk drive is damaged due to over-large colliding force. Although the backup hard disk drive 130 is exemplified to perform data back operation in the invention, the portable computer in the invention can also use a flash disk to backup the data. Owing that the flash disk has small volume and a larger safe shaking range than the hard disk drive, the security of data backup can be improved by using the flash disk. In addition, any other data storage device can also be used to backup the data of the main hard disk drive 120. As long as the data storage device is set to be powered off or in a low power consumption mode, as the portable computer is in a normal mode while awakened to perform data backup operation in as the portable computer is in a backup mode, the purposed of data protection can be achieved and thus all these will not depart from the scope of the invention.

Furthermore, , although the backup hard disk drive 130 is exemplified to be powered off as the portable computer 100 is operated in a normal mode, the backup hard disk drive 130 of the invention can also be in power-unused mode such as a low power consumption mode. As long as the pickup head of the hard disk drive 130 is located at the detent position as operated in the normal mode, the risk that the magnetic surface is bruised by the pickup head to damage the data can be reduced and thus the purpose of data protection can be achieved. Therefore, it will not be apart from the scope of the invention

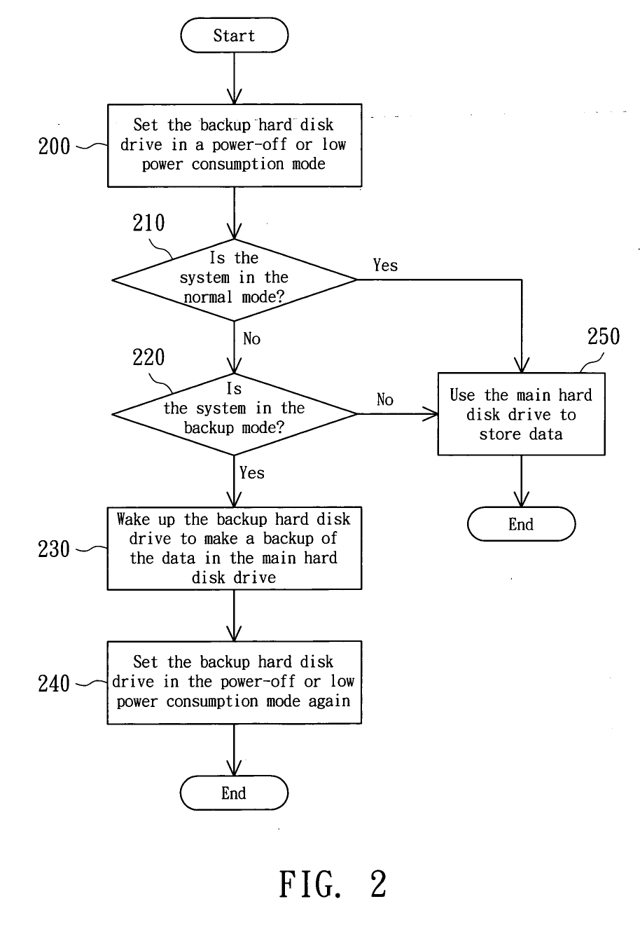

Referring to FIG. 2, a flow chart of a data backup method according to the preferred embodiment of the invention is shown. At first, in step 200, the backup hard disk drive 130 is set in a power-unused mode, such as a power-off mode or a low power consumption mode. Next, in step 210, it is determined whether the portable computer 100 is operated in a normal mode. If the portable computer 100 is operated in a normal mode, the process goes on to the step 250, in which the main hard disk 120 is used to store the data Dn for example, in office hours, and the process is ended. If the portable computer 100 is not operated in a normal mode, the process goes to the step 220 to determine whether the portable computer 100 is operated in a backup mode. If the portable computer 100 is not operated in a backup mode, the process goes to the step 250 to store the data Dn by using the main hard disk drive 120, and then the process is ended.

If the portable computer 100 is operated in a backup mode, the process goes to the step 230. The chipset 110 outputs a backup command Sa to wake up the backup hard disk drive 130 and to backup the data Dn. The portable computer can be set to perform data backup operation automatically, such as perform according to a micro-software embedded schedule, in a predetermined duration, such as in the period when the computer is not used after work, at late night or in the early morning via a software, Or portable computer 100 can be controlled by the user to perform the backup mode at a specific duration

At the time when the computer is not used, such as after work, at late night or in the early morning, the portable computer 100 is usually set in a very stable and complete static situation. Thus, the risk that the hard disk drive 130 is damaged due to collision as doing data backup can be reduced, meanwhile the performance decrease of the portable computer 100 due to backup operation in the normal mode can be prevented.

Furthermore, the content of the backup data can be defined by software or the required backup data Dn can be selected from a monitor of the portable computer 100 by the user. For example, it can be set to backup the data Dn in certain files, the C-track, the D-track, or the whole main hard disk drive 120. If the total data of the main hard disk drive 120 are selected for backup, it should be assured that the backup hard disk drive 130 has enough storage capacity for storing at least the data of the main hard disk drive 120. Or the required backup data Dn can be compressed to backup data Db and then saved into the backup hard disk drive 130.

Finally, in step 240, once the backup process is completed, the backup hard disk drive 130 is set to the power-unused mode, such as a power-off mode or a low power consumption mode again to reduce power consumption and the pick-up head comes back to the detent position.

The portable computer and data backup method thereof disclosed by the above-mentioned embodiment of the invention have the following advantages:
1. The backup hard disk drive embedded in the portable computer is set in a power-unused mode while the portable computer works normally, while in the backup mode, the backup hard disk drive performs the backup operation as the computer system is in a stable and static situation. Therefore, the risk that the magnetic surface is damaged by the pick-up head shaking is decreased, and the security of data backup is increased.
2. Since the backup hard disk drive performs the backup operation while the computer system is in a stable and static situation, not only the risk of damaging the backup hard disk drive can be decreased, but also the performance decrease of the computer system due to backup operation in the normal mode can be prevented.
3. Since the backup hard disk drive is in an Always Off state, and is awakened to perform the backup operation only at a certain time point, the less power is consumed and the external power consumption required for the data backup purpose can be effectively reduced.
4. The backup operation of the invention can be performed automatically by software setting to save time effectively without the need that the user finds extra time perform recording or copying operation by using a CD-R or external hard disk as in the prior art.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable computer, comprising:
a hard disk drive, for storing data; and
a control unit, coupled to the hard disk drive, for outputting a backup command; and
a data storage device, coupled to the control unit, for receiving the backup command and storing the data of the hard disk drive;
wherein when the portable computer is set in a normal mode, the hard disk drive is in a power-on state, and the data storage device is in a power unused mode; when the portable computer is set in a backup mode, the control unit outputs the backup command for waking up the data storage device to store the data of the hard disk drive.

2. The portable computer according to claim 1, wherein the data storage device is a hard disk drive or a flash disk.

3. The portable computer according to claim 1, wherein the control device comprises a chipset and a power supply circuit, the chipset is coupled to the hard disk drive and the data storage device, and the power supply circuit is controlled by the chipset for supplying a power to the data storage device.

4. The portable computer according to claim 3, wherein when the portable computer is set in the backup mode, the chipset controls the power supply circuit to supply the power for powering on the data storage device, and the chipset outputs a signal to wake up the data storage device simultaneously.

5. The portable computer according to claim 3, wherein the chipset is a south bridge chipset.

6. The portable computer according to claim 3, wherein when the portable computer is set in the normal mode, the chipset controls the power supply circuit not to provide the power to the data storage device.

7. The portable computer according to claim 1, wherein the power-unused mode is a low power consumption mode or a power-off mode.

8. The portable computer according to claim 1, wherein the portable computer is a notebook computer or a tablet personal computer.

9. A data backup method, applied in a portable computer, the portable computer comprising a hard disk drive and a data storage device, the data backup method comprising steps of:
setting the data storage device in a power-unused mode, and using the hard disk drive to store data in order to perform a normal-mode operation; and
waking up the data storage device to backup the data of the hard disk drive in order to perform a backup-mode operation.

10. The data backup method according to claim 9, wherein the step of setting the data storage device in the power-unused mode comprising:
setting the data storage device in the power-unused mode;
determining whether the portable computer is in a normal mode, and if yes, using the hard disk drive to store the data; and
determining whether the portable computer is in a backup mode, and if no, using the hard disk drive to store the data.

11. The data backup method according to claim 9, wherein the step of performing the backup mode operation comprises performing the backup operation automatically during a predetermined period.

12. The data backup method according to claim 11, wherein the predetermined period is the time when the portable computer is not used.

13. The data backup method according to claim 11, wherein the predetermined period is set by a software embedded schedule.

14. The data backup method according to claim 11, wherein the data to be copied as a backup by the data storage device are defined by software.

15. The data backup method according to claim 9, wherein the step of performing the backup mode operation comprises controlling the portable computer to perform the backup mode operation via a user.

16. The data backup method according to claim 15, wherein the data to be copied as a backup by the data storage device is selected by the user from a monitor of the portable computer.

17. The data backup method according to claim 9, wherein after the step of performing the backup mode operation, the method further comprises setting the data storage device in the power-unused mode again to complete the backup operation.

18. The data backup method according to claim 9, wherein the data of the hard disk drive are compressed first, and then saved into the data storage device.

19. The data backup method according to claim 9, wherein the data storage device is a hard disk drive or a flash disk.

20. The data backup method according to claim 9, wherein the power-unused mode is a power-off mode or a low power consumption mode.
